(19) United States
(12) Patent Application Publication
(10) Pub. No.: US 2008/0038691 A1
(43) Pub. Date: Feb. 14, 2008

(54) Denture Adjustment Tool

(76) Inventor: Donny T. Walling, Newport, TN (US)

Correspondence Address: LUEDEKA, NEELY & GRAHAM, P.C., P O BOX 1871, KNOXVILLE, TN, 37901, US

(21) Appl. No.: 11/463,691

(22) Filed: Aug. 10, 2006

(51) Int. Cl. A61C 3/06

(52) U.S. Cl. 433/166

(57) ABSTRACT

A denture adjustment tool having a body with a substantially oval shape, a burr having a substantially spherical shape disposed at a first end of the body, and the body and the burr having abrasive surfaces.

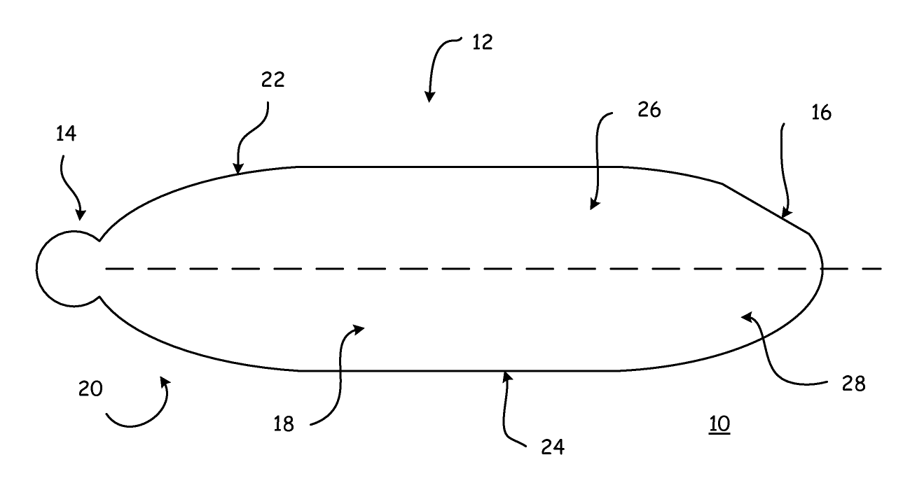

### FIELD

This invention relates to the fields of dentistry. More particularly, this invention relates to a tool for adjusting the fit of dentures.

### BACKGROUND

Dentures are typically formed of a flesh colored acrylic base that fits over the gums. The base of the upper denture typically covers the roof of the mouth, and the base of the lower denture is typically shaped like a horseshoe to accommodate the tongue and the peripheral borders of the upper and lower denture. Dentures are usually custom made in a laboratory from impressions or other measurements that are taken of the patient's mouth.

A full denture is used to replace all of the teeth, such as all of the upper teeth or all of the lower teeth. A partial denture replaces teeth that are missing or have been removed between the remaining teeth. References to dentures as made herein include both full and partial dentures, as appropriate.

Dentures are often not fitted until all of the teeth to be removed have been removed, and the sores have healed. This might take several months, during which time the patient is without some or all of his teeth. During this time, the bones supporting the teeth and the tissues covering the bones tend to reshape. When the healing is substantially complete, then measurements are taken and the denture is fabricated and fitted.

In some circumstances the patient desires to have the dentures fitted immediately upon removal of the teeth. In such a case, approximate measurements are taken prior to the removal of the teeth, and the denture is fabricated based upon these preliminary measurements. Typically, some amount of adjustment of the denture will need to be made prior to the initial fitting, which may occur immediately after the teeth have been removed. However, as the tissues and bones heal thereafter, a great deal more of adjustment—called relining—will need to be done as the tissues and bones of the mouth change shape during the healing process. Even when dentures are fitted after the healing process is substantially complete, a great deal of relining often needs to be done from time to time, such as by the dentist, as the tissues and bones tend to continue to change shape with time.

This relining work is sometimes done by a highly skilled denture technician, who works with sophisticated tools to shape the base of the denture. It is typically a time consuming process for the patient to come in to see the dentist or oral surgeon, explain the problem with the denture, such as where soreness is occurring, have new measurements made as necessary, send the denture to the denture technician, and await the relining and return of the denture. The length of time required by this process, the expense incurred, and the inconvenience of being without teeth for some length of time tends to make the process quite disagreeable to the patient. Often, a patient will just put up with some amount of discomfort for as long as he can, just so that he does not have to go through this difficult process.

What is needed, therefore, is a means by which problems such as those described above can be reduced, at least in part.

### SUMMARY

The above and other needs are met by a denture adjustment tool having a body with a substantially oval shape, a burr having a substantially spherical shape disposed at a first end of the body, and the body and the burr having abrasive surfaces.

In this manner, the denture wearer is able to use the tool to make his own minor modifications to his dentures. Thus, the time, expense, and inconvenience associated with having a dentist and denture technician make relatively minor adjustments to the denture are removed.

In various embodiments, the body has a flat edge portion in the substantially oval shape. The flat edge portion may be disposed at a second end of the body opposite the first end of the body. The denture adjustment tool is preferably formed of at least one of metal, wood, and plastic. Most preferably, the body and the burr are formed as a single piece of material.

The abrasive surfaces of the body and the burr may be formed directly into materials from which the body and burr are formed, or alternately are formed by at least one of adhering and impregnating an abrasive grit into surfaces of the body and the burr. The abrasive surfaces of the body and the burr preferably have different grades of abrasiveness in different portions of the denture adjustment tool. In one embodiment, the abrasive surfaces of the body and the burr are formed with carbide particles.

In a preferred embodiment, the burr has an abrasive surface with a coarsest relative degree of abrasiveness, a first side of the body has an abrasive surface with a medium relative degree of abrasiveness, and a second opposing side of the body has an abrasive surface with a finest relative degree of abrasiveness. In one specific embodiment, the burr has an abrasive surface with an abrasiveness grade of about thirty grit, a first side of the body has an abrasiveness grade of about sixty grit, and a second opposing side of the body has an abrasiveness of about one hundred grit.

One embodiment of the denture adjustment tool has an overall length of about one hundred and ten millimeters and width at its widest point of about thirty millimeters, where the body has a thickness of about five millimeters and the burr has a diameter of about ten millimeters. Most preferably the tool is formed of injection molded plastic and the abrasive surfaces are formed of carbide particles that have been at least one of glued onto and at least partially impregnated into the injection molded plastic.

### BRIEF DESCRIPTION OF THE DRAWINGS

Further advantages of the invention are apparent by reference to the detailed description when considered in conjunction with the figure, which is not to scale so as to more clearly show the details, wherein like reference numbers indicate like elements, and which depicts a denture adjustment tool according to the present invention.

### DETAILED DESCRIPTION

With reference now to the figure, there is depicted a tool 10 adapted for the adjustment of dentures. The tool 10 is preferably formed of two major portions, being a body 12 and a burr 14. While the body 12 and the burr 14 may be formed in two separate pieces and of two different materials which are then joined together, they are more preferably formed as a single piece of one material. The body 12 and the burr 14 may be formed, for example of wood, metal, plastic, or other material that has a rigidity and strength similar to these materials. In a preferred embodiment, the tool 10 is molded as a single piece of plastic.

The tool 10 preferably has an overall length of about one hundred and ten millimeters, and width at its widest point of about thirty millimeters. The body 12 is preferably generally oval in shape and flat, with a thickness of about five millimeters. The burr 14 is preferably substantially spherical, with a diameter of about ten millimeters, and joins the body 12 at one end of the generally oval shape of the body 12. The term “substantially spherical” as used herein includes a range of structures, from completely spherical to something just less than hemispherical, including structures that are not completely evenly formed, but have generally round or ovate cross-sections. The tool 10 is preferably shaped and sized so as to fit easily and comfortably within the palm of the hand of the patient, who will use it to adjust the fit of a denture.

At the other end of the body 12, opposite from the burr 14, the body 10 preferably has a relatively flatter portion 16. the flatter portion 16 may be completely flat, or might alternately be only somewhat flatter than the natural curve of the generally oval shape of the body 12 at that end.

The tool 10 preferably has a rough surface, sufficient to abrade and remove material from the base of a denture, such as is commonly formed of acrylic. Preferably, the rough surface of the tool 10 is designed such that it either will not load with the acrylic material and become clogged, thus reducing its abrasive qualities, or alternately can be easily cleaned of the material that it removes from the denture, so that it can continue to remove material from the denture. Thus, the tool 10 is adapted to be rubbed against the base of a denture, and wear away material of the denture as desired, such as to improve the fit of the denture.

The abrasive surface of the tool 10 is preferably constructed so as to be relatively harder than the material of the denture, so that the abrasive surface does not wear away too quickly and become ineffectual in adjusting the denture. If the material of which the tool 10 itself is formed meets these criteria of itself, then the abrasive surface of the tool can be formed directly into the material of the tool 10. For example, if the tool 10 is formed of metal, then the abrasive surface of the tool 10 can be formed directly into the metal, such as like a file or rasp. Alternately, an abrasive material can be adhered to the surface of the tool 10 in some manner, to provide the abrasive surface. For example, a carbide or other grit can be glued or partially impregnated into the surface of the tool 10, to form the abrasive surface of the tool 10.

Most preferably, different portions of the tool 10 have surfaces with different levels of abrasiveness. For example, the burr 14 is most preferably relatively more abrasive than other portions of the tool 10. In one embodiment, the burr 14 has a grade 40 grit. In one embodiment, one side 18 of the body 12 has a finer abrasiveness than the other side 20. For example, the one side 18 of the body 12 may have a grade 60 grit, and the other side 20 has a grade 100 grit. Similarly, the circumferential edges of the body 12 may have an abrasiveness that is different from all of the other surfaces of the tool 10. Alternately, the top edge 22 of the tool 10 may have an abrasiveness that is the same as one of the front 18 or the back 20 of the tool 10. The bottom edge 24 of the tool 10 may have an abrasiveness that is equal to the other of the front 18 or the back 20 of the tool 10, so that the top edge 22 and the bottom edge 24 have different levels of abrasiveness.

The flat portion 16 of the body 10 may have an abrasiveness that is different from all other surfaces of the tool 10, or it may have an abrasiveness that is the same as the edge 22 or other surface of the tool 10. In yet another embodiment, an upper half 26 of the body 12 has one level of abrasiveness on both sides 18 and 20 of the tool 10, and the lower half 28 of the body 12 has a different level of abrasiveness on both sides 18 and 20 of the tool 10. Alternately, one end of the body 12 of the tool 10 may have an abrasiveness that is different from the other end of the body 12 of the tool 10. Thus, many different configurations of abrasiveness are anticipated by this invention, with the goal of providing embodiments having different surfaces, angles, and abrasiveness on the tool 10, such that it is useful for making a wide variety of adjustments to the different surfaces of the base of the denture.

The tool 10 is preferably used by the person who wears the denture, to shape the denture to alleviate spots in the base of the denture that are causing discomfort. For example, the user might use the burr 14 to form a hollow in the denture base where there is a protrusion in the gums. The different surfaces of the body 12 can be used to remove material from the base of the denture in an area of more general discomfort, such as to widen a portion of the base. The coarser abrasive surfaces of the tool 10 can be used first to remove a greater portion of the denture material, and then the finer abrasive surfaces of the tool 10 can be used to smooth those areas of the denture that have been adjusted, or to adjust the denture with a finer degree of control or otherwise make smaller adjustments.

In this manner, the denture wearer is able to use the tool 10 to make his own minor modifications to his dentures. Thus, the time, expense, and inconvenience associated with having a dentist and denture technician make relatively minor adjustments to the denture are removed.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A denture adjustment tool comprising:
a body having a substantially oval shape,
a burr having a substantially spherical shape disposed at a first end of the body, and
the body and the burr having abrasive surfaces.

2. The denture adjustment tool of claim 1, wherein the body has a flat edge portion in the substantially oval shape, the flat edge portion disposed at a second end of the body opposite the first end of the body.

3. The denture adjustment tool of claim 1, wherein the denture adjustment tool is formed of at least one of metal, wood, and plastic.

4. The denture adjustment tool of claim 1, wherein the body and the burr are formed as a single piece of material.

5. The denture adjustment tool of claim 1, wherein the abrasive surfaces of the body and the burr are formed directly into materials from which the body and burr are formed.

6. The denture adjustment tool of claim 1, wherein the abrasive surfaces of the body and the burr are formed by at least one of adhering and impregnating an abrasive grit into surfaces of the body and the burr.

7. The denture adjustment tool of claim 1, wherein the abrasive surfaces of the body and the burr have different grades of abrasiveness in different portions of the denture adjustment tool.

8. The denture adjustment tool of claim 1, wherein the abrasive surfaces of the body and the burr are formed with carbide particles.

9. The denture adjustment tool of claim 1, wherein the burr has an abrasive surface with a coarsest relative degree of abrasiveness, a first side of the body has an abrasive surface with a medium relative degree of abrasiveness, and a second opposing side of the body has an abrasive surface with a finest relative degree of abrasiveness.

10. The denture adjustment tool of claim 1, wherein the burr has an abrasive surface with an abrasiveness grade of about thirty grit, a first side of the body has an abrasiveness grade of about sixty grit, and a second opposing side of the body has an abrasiveness of about one hundred grit.

11. The denture adjustment tool of claim 1, wherein the denture adjustment tool has an overall length of about one hundred and ten millimeters and width at its widest point of about thirty millimeters, the body has a thickness of about five millimeters, and the burr has a diameter of about ten millimeters.

12. The denture adjustment tool of claim 1, wherein the tool is formed of injection molded plastic and the abrasive surfaces are formed of carbide particles that have been at least one of glued onto and at least partially impregnated into the injection molded plastic.

13. A denture adjustment tool comprising:
a body having a substantially oval shape,
a burr having a substantially spherical shape disposed at a first end of the body, and
the body and the burr having abrasive surfaces,
where the body and the burr are formed of a single piece of plastic.

14. The denture adjustment tool of claim 13, wherein the abrasive surfaces of the body and the burr are formed directly into the plastic.

15. The denture adjustment tool of claim 13, wherein the abrasive surfaces of the body and the burr are formed by at least one of adhering and impregnating an abrasive grit into surfaces of the body and the burr.

16. The denture adjustment tool of claim 13, wherein the abrasive surfaces of the body and the burr have different grades of abrasiveness in different portions of the denture adjustment tool.

17. The denture adjustment tool of claim 13, wherein the burr has an abrasive surface with a coarsest relative degree of abrasiveness, a first side of the body has an abrasive surface with a medium relative degree of abrasiveness, and a second opposing side of the body has an abrasive surface with a finest relative degree of abrasiveness.

18. The denture adjustment tool of claim 13, wherein the denture adjustment tool has an overall length of about one hundred and ten millimeters and width at its widest point of about thirty millimeters, the body has a thickness of about five millimeters, and the burr has a diameter of about ten millimeters.

19. A denture adjustment tool comprising:
a body having a substantially oval shape,
a burr having a substantially spherical shape disposed at a first end of the body, and
the body and the burr having abrasive surfaces, wherein the burr has an abrasive surface with a coarsest relative degree of abrasiveness, a first side of the body has an abrasive surface with a medium relative degree of abrasiveness, and a second opposing side of the body has an abrasive surface with a finest relative degree of abrasiveness,
where the body and the burr are formed of a single piece of plastic having an overall length of about one hundred and ten millimeters and width at its widest point of about thirty millimeters, the body has a thickness of about five millimeters, and the burr has a diameter of about ten millimeters.

20. The denture adjustment tool of claim 19, wherein the abrasive surfaces of the body and the burr are formed with carbide particles.
